(19) United States
(12) Patent Application Publication
(10) Pub. No.: US 2012/0085115 A1
(43) Pub. Date: Apr. 12, 2012

(54) AIR CONDITIONER FOR VEHICLE

(75) Inventors: Myung Hoe KIM, Seoul (KR); Seon Won Kim, Hwaseong-si (KR); Seung Wook Kim, Suwon-si (KR); Jong Heon Lee, Suwon-si (KR)

(73) Assignees: Kia Motors Corp., Seoul (KR); Hyundai Motor Company, Seoul (KR)

(21) Appl. No.: 12/956,283

(22) Filed: Nov. 30, 2010

(30) Foreign Application Priority Data
Oct. 8, 2010 (KR) 10-2010-0098290

(51) Int. Cl. B60H 1/00

(52) U.S. Cl. 62/239

(57) ABSTRACT

An air conditioner for a vehicle may include an evaporator core, a heater core allowing air which has passed through the evaporator core to selectively pass therethrough, a defrost outlet, a vent outlet formed adjacent to the defrost outlet, a floor outlet formed adjacent to the vent outlet, and a sliding door sliding between the defrost outlet, the vent outlet and the floor outlet in series, thus selectively opening or closing the defrost outlet, the vent outlet and the floor outlet.

### CROSS-REFERENCE TO RELATED APPLICATIONS

The present application claims priority to Korean Patent Application No. 10-2010-0098290 filed on Oct. 8, 2010, the entire contents of which is incorporated herein for purposes by this reference.

### BACKGROUND OF THE INVENTION

1. Field of the Invention

The present invention relates generally to an air conditioner for a vehicle and, more particularly, to an air conditioner for a vehicle, which is constructed to open or close a defrost outlet, a vent outlet and a floor outlet using a single sliding door.

2. Description of Related Art

Generally, an air conditioner for a vehicle is constructed so that ambient air introduced into the interior of the vehicle by a blower unit passes selectively through an evaporator in which a refrigerant circulates or a heater core in which the coolant of a vehicle engine circulates to perform a heat exchange process, and cold or warm air is distributed through outlets communicating with various portions of the vehicle, thereby cooling or heating the interior of the vehicle.

In various modes, the air conditioner discharges cold or warm air to various portions of the vehicle. FIG. 1 is a view showing the construction of a conventional 3-door type air conditioner for a vehicle, and FIG. 2 is a view showing the construction of a conventional 2-door type air conditioner for a vehicle.

As shown in FIG. 1, the conventional 3-door type air conditioner generally includes a defrost door 1, a vent door 3 and a floor door 5 to control the volume of air that is discharged to a defrost outlet 1a, a vent outlet 3a and a floor outlet 5a.

Meanwhile, as shown in FIG. 2, the conventional 2-door type air conditioner controls the volume of air that is discharged to a defrost outlet 1a, a vent outlet 3a and a floor outlet 5a using two doors, that is, a defrost and vent door 7 and a floor door 5.

The conventional 3-door or 2-door type air conditioner is problematic in that a door needs to be individually installed at each outlet, so that the number of parts and weight are increased, and thus the cost of manufacturing is increased. Further, in the case of mechanically operating the doors, two or three door must be operated at once using one cam, so that working load imposed on the cam increases, thus causing frequent failures.

Moreover, the conventional 2-door type air conditioner is problematic in that the defrost outlet and the vent outlet must be controlled by one defrost and vent door, so that the size of the door increases, thus causing the flow of air to generate vibrations and noise, and the path of the defrost outlet becomes narrow, so that resistance to air is increased, and air volume is relatively reduced.

The information disclosed in this Background of the Invention section is only for enhancement of understanding of the general background of the invention and should not be taken as an acknowledgement or any form of suggestion that this information forms the prior art already known to a person skilled in the art.

### BRIEF SUMMARY OF THE INVENTION

Various aspects of the present invention are directed to provide an air conditioner for a vehicle, which is capable of controlling all of a defrost outlet, a vent outlet and a floor outlet using a single sliding door.

In an aspect of the present invention, the air conditioner for a vehicle may include an evaporator core, a heater core allowing air which may have passed through the evaporator core to selectively pass therethrough, a defrost outlet, a vent outlet formed adjacent to the defrost outlet, a floor outlet formed adjacent to the vent outlet, and a sliding door sliding between the defrost outlet, the vent outlet and the floor outlet in series, thus selectively opening or closing the defrost outlet, the vent outlet and the floor outlet, wherein a positive temperature coefficient (PTC) may be disposed adjacent to the heater core.

A temperature control door may be disposed between the evaporator core and the heater core and PTC.

A temperature control door may be disposed between the evaporator core and the heater core.

The sliding door may have a predetermined curvature.

A driving shaft may be provided in the air conditioner and driving gears may be formed both ends of the driving shaft, and rack gears may be provided along upper and lower ends of the sliding door in an inner surface of the sliding door and may be spaced apart from each other by a predetermined interval to engage with the driving gears, wherein the driving shaft may be provided between the defrost outlet and the vent outlet and wherein the sliding door may have a predetermined curvature.

The sliding door may be made of a material in a form of a thin plate enough to allow the curvature thereof to change.

The sliding door may include a first closing part, an opening, and a second closing part which may be adjacent to each other, wherein a width of the opening may be substantially the same as a width of the vent outlet so that a position of the opening may be precisely aligned with a position of the vent outlet in a vent mode.

A width of the first closing part may be equal to or larger than a sum of a width of the defrost outlet and a width of the vent outlet.

A width of the first closing part may be equal to or larger than a sum of a width of the vent outlet and a width of the floor outlet.

The methods and apparatuses of the present invention have other features and advantages which will be apparent from or are set forth in more detail in the accompanying drawings, which are incorporated herein, and the following Detailed Description of the Invention, which together serve to explain certain principles of the present invention.

### BRIEF DESCRIPTION OF THE DRAWINGS

FIG. 1 is a view showing a conventional 3-door type air conditioner for a vehicle.

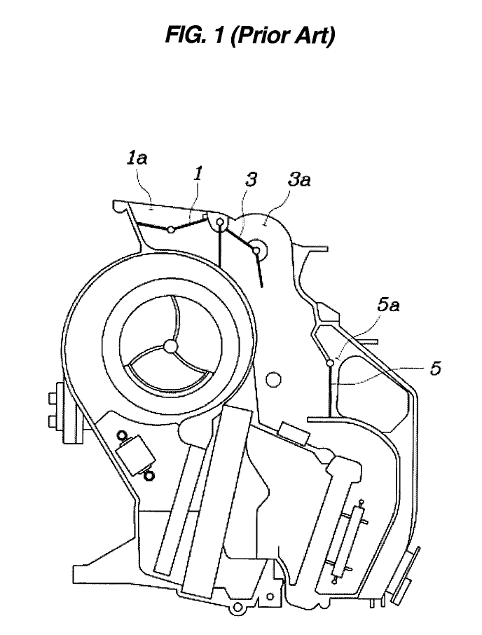

FIG. 2 is a view showing a conventional 2-door type air conditioner for a vehicle.

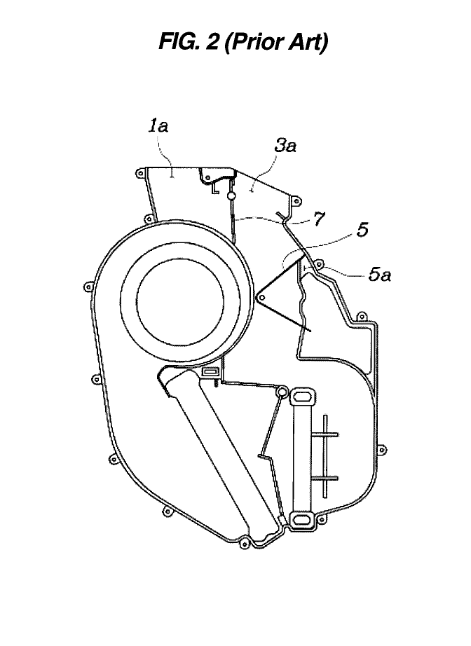

FIG. 3 is a view showing an air conditioner for a vehicle according to an exemplary embodiment of the present invention.

FIG. 4 is a view showing a sliding door which is applied to the present invention.

FIGS. 5A to 5E are views showing the operation of the air conditioner for the vehicle according to an exemplary embodiment of the present invention.

It should be understood that the appended drawings are not necessarily to scale, presenting a somewhat simplified representation of various features illustrative of the basic principles of the invention. The specific design features of the present invention as disclosed herein, including, for example, specific dimensions, orientations, locations, and shapes will be determined in part by the particular intended application and use environment.

In the figures, reference numbers refer to the same or equivalent parts of the present invention throughout the several figures of the drawing.

### DETAILED DESCRIPTION OF THE INVENTION

Reference will now be made in detail to various embodiments of the present invention(s), examples of which are illustrated in the accompanying drawings and described below. While the invention(s) will be described in conjunction with exemplary embodiments, it will be understood that present description is not intended to limit the invention(s) to those exemplary embodiments. On the contrary, the invention(s) is/are intended to cover not only the exemplary embodiments, but also various alternatives, modifications, equivalents and other embodiments, which may be included within the spirit and scope of the invention as defined by the appended claims.

Hereinafter, an air conditioner for a vehicle according to the exemplary embodiment of the present invention will be described with reference to the accompanying drawings.

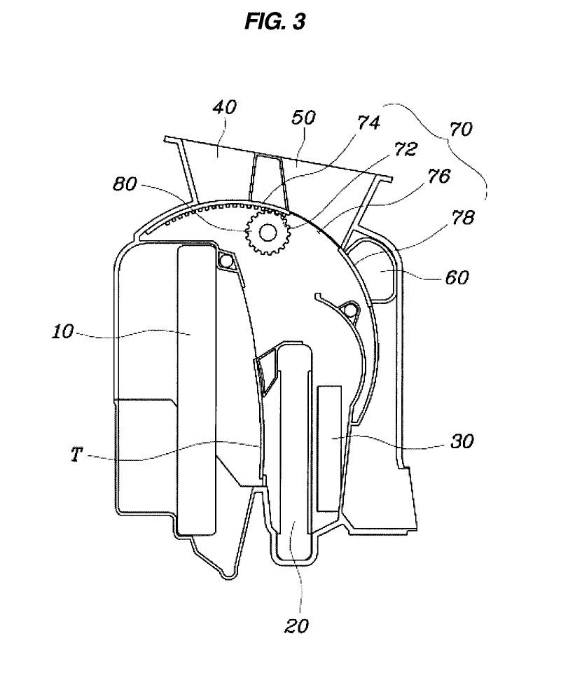

Referring to FIG. 3, the air conditioner for the vehicle according to an exemplary embodiment of the present invention includes an evaporator core 10, a heater core 20, a positive temperature coefficient (PTC) 30, a defrost outlet 40, a vent outlet 50, a floor outlet 60 and a sliding door 70.

A refrigerant circulates in the evaporator core 10. While air introduced into the air conditioner by a blower passes through the evaporator core 10, a heat exchange process is performed, so that the air is changed into cold air.

The cold air selectively passes through the heater core 20 by adjusting the opening ratio of a temperature control door T. Thus, the cold air may bypass the heater core 20 so that the cold air is directly discharged to each outlet 40, 50 or 60. Further, some of the cold air may pass through the heater core 20 to be changed into warm air.

Further, after the air has passed through the heater core 20, the air passes through the PTC 30 which is placed behind the heater core 20. The PTC 30 is a separate electric heating device which is installed to increase the temperature of the air introduced into the heater core 20 and improve the heating performance of the vehicle. Such a PTC 30 is integrated with the heater core 20, thus functioning to raise the internal air temperature of the vehicle in winter as quickly as possible.

Meanwhile, the air which has passed through the evaporator core 10, the heater core 20, and the PTC 30 is discharged to the defrost outlet 40, the vent outlet 50, and the floor outlet 60. Here, the volume of the air discharged to each outlet 40, 50 or 60 may be controlled by a driver's manipulation of controls. This function is performed by the sliding door 70.

The sliding door 70 moves between the defrost outlet 40, the vent outlet 50 and the floor outlet 60 to open or close each outlet 40, 50 or 60 and control the opening ratio thereof. That is, as a single sliding door 70 moves leftwards or rightwards, the defrost outlet 40, the vent outlet 50 and the floor outlet 60 are selectively opened or closed.

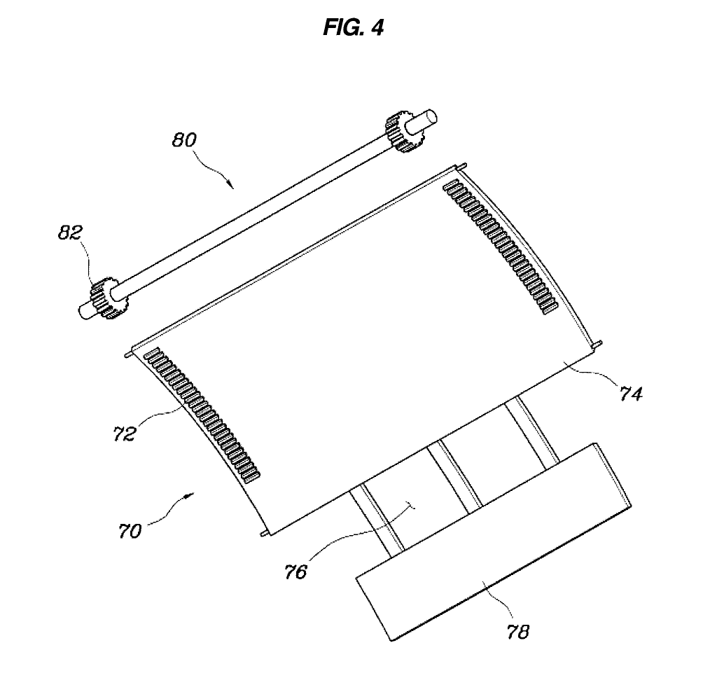

As shown in FIGS. 3 and 4, the sliding door 70 includes a first closing part 74, an opening 76, and a second closing part 78 which are continuously arranged to be adjacent to each other. Several rack gears 72 are provided on the upper and lower ends of the sliding door 70 in such a way as to be spaced apart from each other by a predetermined distance.

A driving shaft 80 is provided between the defrost outlet 40 and the vent outlet 50, and driving gears 82 are provided, respectively, on the upper and lower ends of the driving shaft 80. Since the driving gears 82 engage with the rack gears 72 which are provided on the upper and lower ends of the sliding door 70, the sliding door 70 may slide leftwards or rightwards when the driving shaft 80 is rotated.

It is preferable that the sliding door 70 be formed to have a predetermined curvature. Since the sliding door 70 has the predetermined curvature, sealing ability is improved when the sliding door 70 closes each outlet 40, 50 or 60. Further, if the sliding door 70 is made of a material in the form of a thin plate, the central portion of the sliding door 70 is bent by the air flow, and both sides thereof are seated on sides of each outlet 40, 50 or 60, so that the sealing ability is further improved. That is, the curvature changes freely in relation to the intensity of wind or the like so as to improve the sealing ability.

When a driver desires to open only the vent outlet 50, the position of the opening 76 is precisely aligned with the position of the vent outlet 50, so that cooling and heating efficiency can be maximized. Further, it is preferable that the width of the first closing part 74 be equal to or larger than the sum of the width of the vent outlet 40 and the width of the floor outlet 60, in order for the first closing part 74 to completely close the vent outlet 40 and the floor outlet 60 in defrost mode.

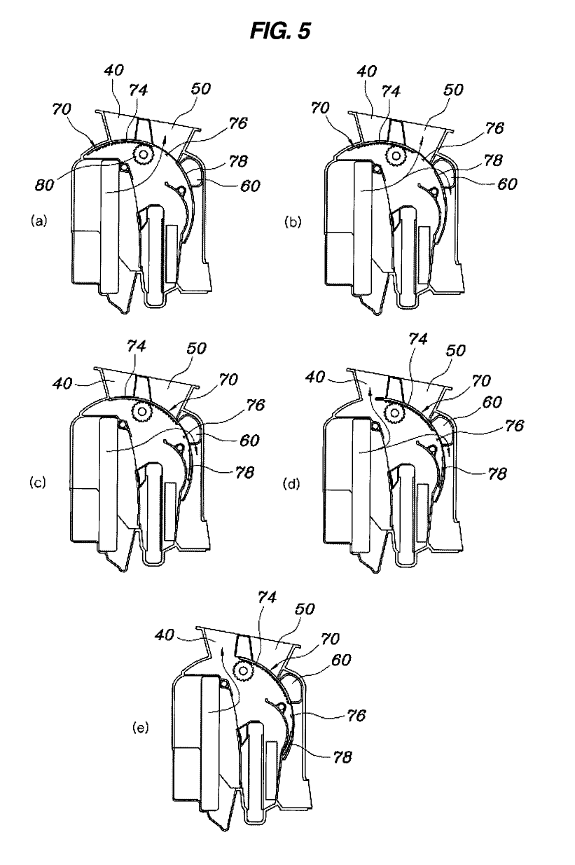

The operation of the air conditioner for the vehicle according to an exemplary embodiment of the present invention will be described with reference to FIGS. 5A to 5E.

FIG. 5A is a view showing vent mode. The opening 76 of the sliding door 70 is located to precisely correspond to the vent outlet 50, and the first closing part 74 and the second closing part 78 are located, respectively, to correspond to the defrost outlet 40 and the floor outlet 60, thus blocking the air flow.

FIG. 5B is a view showing bi-lever mode. If the first closing part 74 moves a predetermined distance, the opening 76 and the second closing part 78 also move. At this time, the opening width of the vent outlet 50 is reduced in comparison with the opening width shown in FIG. 5A, but the floor outlet 60 is opened by a predetermined width.

FIG. 5C is a view showing floor mode. When the first closing part 74 moves to close the defrost outlet 40 and the vent outlet 50, the opening 76 is located to precisely correspond to the floor outlet 60, and air is discharged towards a passenger's feet.

FIG. 5D is a view showing mixed mode. If the sliding door 70 further moves a predetermined distance from the position of FIG. 5C, both ends of the first closing part 74 are placed over the defrost outlet 40 and the floor outlet 60. At this time, the vent outlet 50 is completely closed by the first closing part 74, but the defrost outlet 40 and the floor outlet 60 are open by predetermined widths.

FIG. 5E is a view showing defrost mode. If the sliding door 70 further moves a predetermined distance from the position of FIG. 5D, the vent outlet 50 and the floor outlet 60 are completely closed by the first closing part 74. At this time, the defrost outlet 40 is completely opened.

For convenience in explanation and accurate definition in the appended claims, the terms “upper”, “lower”, “inner” and “outer” are used to describe features of the exemplary embodiments with reference to the positions of such features as displayed in the figures.

The foregoing descriptions of specific exemplary embodiments of the present invention have been presented for purposes of illustration and description. They are not intended to be exhaustive or to limit the invention to the precise forms disclosed, and obviously many modifications and variations are possible in light of the above teachings. The exemplary embodiments were chosen and described in order to explain certain principles of the invention and their practical application, to thereby enable others skilled in the art to make and utilize various exemplary embodiments of the present invention, as well as various alternatives and modifications thereof. It is intended that the scope of the invention be defined by the Claims appended hereto and their equivalents.

What is claimed is:

1. An air conditioner for a vehicle, comprising:
an evaporator core;
a heater core allowing air which has passed through the evaporator core to selectively pass therethrough;
a defrost outlet;
a vent outlet formed adjacent to the defrost outlet;
a floor outlet formed adjacent to the vent outlet; and
a sliding door sliding between the defrost outlet, the vent outlet and the floor outlet in series, thus selectively opening or closing the defrost outlet, the vent outlet and the floor outlet.

2. The air conditioner as set forth in claim 1, wherein a positive temperature coefficient (PTC) is disposed adjacent to the heater core.

3. The air conditioner as set forth in claim 2, wherein a temperature control door is disposed between the evaporator core and the heater core and PTC.

4. The air conditioner as set forth in claim 1, wherein a temperature control door is disposed between the evaporator core and the heater core.

5. The air conditioner as set forth in claim 1, wherein the sliding door has a predetermined curvature.

6. The air conditioner as set forth in claim 1, wherein a driving shaft is provided in the air conditioner and driving gears is formed both ends of the driving shaft, and rack gears are provided along upper and lower ends of the sliding door in an inner surface of the sliding door and are spaced apart from each other by a predetermined interval to engage with the driving gears.

7. The air conditioner as set forth in claim 6, wherein the driving shaft is provided between the defrost outlet and the vent outlet.

8. The air conditioner as set forth in claim 6, wherein the sliding door has a predetermined curvature.

9. The air conditioner as set forth in claim 8, wherein the sliding door is made of a material in a form of a thin plate enough to allow the curvature thereof to change.

10. The air conditioner as set forth in claim 1, wherein the sliding door comprises a first closing part, an opening, and a second closing part which are adjacent to each other.

11. The air conditioner as set forth in claim 10, wherein a width of the opening is substantially the same as a width of the vent outlet so that a position of the opening is precisely aligned with a position of the vent outlet in a vent mode.

12. The air conditioner as set forth in claim 11, wherein a width of the first closing part is equal to or larger than a sum of a width of the defrost outlet and a width of the vent outlet.

13. The air conditioner as set forth in claim 11, wherein a width of the first closing part is equal to or larger than a sum of a width of the vent outlet and a width of the floor outlet.
